(19) United States
(12) Patent Application Publication
(10) Pub. No.: US 2017/0105330 A1
(43) Pub. Date: Apr. 20, 2017

(54) METHOD AND APPARATUS FOR MOUNTING RAKES AND OTHER AGRICULTURAL IMPLEMENTS

(71) Applicant: DON MASHBURN, INC., Broussard, LA (US)

(72) Inventor: BENNY DONALD MASHBURN, BROUSSARD, LA (US)

(21) Appl. No.: 15/290,598

(22) Filed: Oct. 11, 2016

Related U.S. Application Data
(60) Provisional application No. 62/243,741, filed on Oct. 20, 2015.

(51) Int. Cl. A01B 59/06; A01D 78/00

(52) U.S. Cl. CPC A01B 59/064; A01D 78/001

(57) ABSTRACT

A mounting assembly for operationally attaching an agricultural implement (including, without limitation, a rake assembly) to the front of a tractor or other motorized vehicle. The mounting assembly permits responsive turning of an attached agricultural implement. A suspension assembly allows use over uneven terrain and maintains desired contact with such terrain. Among other benefits, the mounting assembly permits the use of a first agricultural implement in front of a tractor or other motorized vehicle, while a second agricultural implement can be pulled or towed behind the tractor or vehicle; thus, multiple operations can be combined, thereby greatly improving efficiency, cost effectiveness and environmental impact of such operations.

### BACKGROUND OF INVENTION

1. Field of the Invention

The present invention pertains to a mounting assembly for operating agricultural implements such as, for example, hay or grass rakes. More particularly, the present invention pertains to a mounting assembly for operationally attaching an agricultural implement to a tractor or other similar vehicle, in order to operate such implement in a controlled, effective, and efficient manner. More particularly still, the present invention pertains to a mounting assembly for operationally attaching an agricultural implement to the front or leading surface of a tractor or other motor vehicle.

2. Brief Description of the Prior Art

Agricultural operations can be labor and equipment-intensive work. Many such agricultural operations are multi-step processes. For example, one such common agricultural operation, baling of grass or hay, is typically performed as a three step process; grass is first cut during one operation using a cutting implement, raked into rows in a second operation using a rake implement, and then formed into bails using a bailer during yet a third operation. In some cases, inclement weather can delay one or more of these steps, thereby extending the length of the overall operation.

If at least two steps of a multi-step process can be combined, a user can save time and expense by making the overall operation more efficient. For example, after grass has been cut, combining the raking and bailing operations can significantly reduce the length and cost of the overall operation; in certain circumstances, this reduction can help avoid inclement weather and unwanted delays associated therewith. Further, combining of multiple operations can also conserve fuel consumption and reduce pollution including, without limitation, exhaust emissions.

One way to accomplish a combination of multiple operations would be to push or tow a first implement in front of a tractor or other motorized vehicle, while simultaneously pulling a second implement behind said tractor or other vehicle. However, to date, pushing or towing of an agricultural implement in front of a tractor or other vehicle has not been a viable option because such a configuration would create a variety of different problems including, without limitation, accurately steering said implement while maintaining said implement in a relatively level and stable orientation, particularly over uneven or difficult terrain.

Thus, there is a need for a mounting assembly that permits operational attachment of an agricultural implement to the front or leading surface of a tractor or other motorized vehicle. The mounting assembly should beneficially permit control, maneuverability, and efficiency throughout performance of an agricultural operation including, without limitation, a multi-step operation. More particularly, the mounting assembly should beneficially permit operational attachment of a separate/different agricultural implement to the rear or trailing surface of a tractor or other motorized vehicle.

### SUMMARY OF INVENTION

The present invention generally comprises a mounting assembly for use in operationally attaching an agricultural implement to a tractor or other motorized vehicle including, without limitation, to the front or forward facing surface of said tractor or other vehicle. More specifically, the mounting assembly of the present invention permits front mounting of an implement (including, without limitation, a front-mounted implement that is typically towed behind a tractor) and operation thereof in a controlled and effective manner.

In a preferred embodiment, the mounting assembly of the present invention comprises a frame assembly having a elongate and substantially rigid central beam member. A connection assembly is disposed at a first end of said frame in order to operationally attach said mounting assembly to a tractor or other motorized vehicle. Said connection assembly is sufficiently rigid to have desirable strength characteristics, while also being sufficiently flexible to beneficially permit said frame to “float” over different types of terrain.

In a preferred embodiment, the mounting assembly of the present invention also comprises a steering system. Said steering system can be “passive”, such that an operationally attached agricultural implement can alternatively turn and/or straighten (typically in response to a turn by a tractor). Further, said steering system can work in conjunction with a suspension assembly, thereby properly sustaining full and substantially consistent contact between a mounted implement and an underlying surface and/or vegetation situated thereon. Said suspension assembly keeps such an implement from lifting while turning, and thus, skipping large sections of underlying terrain or associated vegetation.

In a preferred embodiment, said steering system can comprise a slip-joint type rear steering mechanism. The leading end of an agricultural implement operationally attached to the mounting assembly is “pulled”; as such, the remainder of the mounting assembly can thus pivot about a fixed radius in order to assist in turning. Even during turning operations, an attached implement is maintained in proper contact with an underlying surface. When steering is straightened, a forward motion of the front hitch can bring said attached implement back to a straight row operation.

Additionally, steering of said mounting assembly can be dampened and/or controlled by at least one optional motor. Further, a “centering” mechanism can be employed in order to center the mounting assembly while said mounting assembly is being lifted and transported, thereby providing a means to lock said mounting assembly in place as an additional safety measure.

### BRIEF DESCRIPTION OF DRAWINGS

The foregoing summary, as well as any detailed description of the preferred embodiment, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts an overhead perspective view of an agricultural implement mounting assembly of the present invention operationally attached to the front of a tractor.

FIG. 2 depicts a rear perspective view of an agricultural implement mounting assembly of the present invention.

FIG. 3 depicts a front perspective view of an agricultural implement mounting assembly of the present invention.

FIG. 4 depicts an overhead view of an agricultural implement mounting assembly of the present invention.

FIG. 5 depicts a side view of an agricultural implement mounting assembly of the present invention.

FIG. 6 depicts a perspective view of a front portion of an agricultural implement mounting assembly of the present invention.

FIG. 7 depicts a side view of an agricultural implement mounting assembly of the present invention during a raking and bailing operation.

FIG. 8 depicts an overhead view of an agricultural implement mounting assembly of the present invention during a raking and bailing operation.

FIG. 9 depicts an overhead view of an agricultural implement mounting assembly of the present invention while being turned during a raking operation.

### DETAILED DESCRIPTION OF A PREFERRED EMBODIMENT

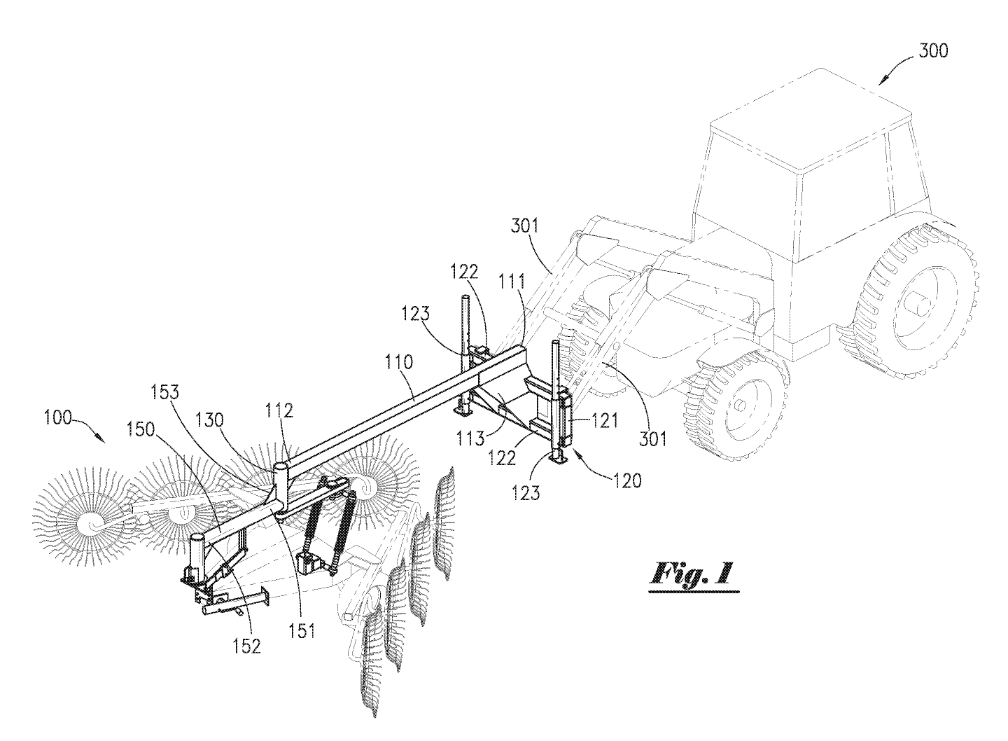

FIG. 1 depicts an overhead perspective view of an agricultural implement mounting assembly 100 of the present invention operationally attached to a tractor 300. Mounting assembly 100 of the present invention permits mounting of an agricultural implement such as a rake or other assembly to the front or forward facing end of a tractor (such as tractor 300) or other motorized vehicle. As such, mounting assembly 100 of the present invention permits use of a front-mounted agricultural implement in a controlled and effective manner as disclosed more fully herein.

Still referring to FIG. 1, in a preferred embodiment, mounting assembly 100 generally comprises a substantially rigid frame. More specifically, said frame comprises elongate central beam member 110 having a first or proximate end 111 and second or distal end 112. Rear mounting frame assembly 120 is disposed at said proximate end 111 and permits operational attachment of said mounting assembly 100 to forward facing loader arms 301 of tractor 300. It is to be observed that the specific operational attachment of mounting assembly 100 to tractor 300 depicted in FIG. 1 is illustrative only and is not intended to be limiting in any way; said mounting assembly 100 can be operationally attached to the front portion of a tractor other motorized vehicle, even if not equipped with such loader arms 301 depicted in FIG. 1, without departing from the scope of the present invention.

Although other connection interfaces can be contemplated without departing from the scope of the present invention, in a preferred embodiment said rear mounting assembly 120 forms a substantially rectangular frame for operational attachment to loader arms 301 of tractor 300. Said mounting frame 120 comprises rigid horizontal frame members 122 that extend between rigid vertical frame members 121. At least one adjustable jack stand 123 can be attached to said mounting frame 120, while gusset support frame 113 reinforces and provides structural support to the connection of central beam 110 to mounting frame 120. As depicted in FIG. 1, central beam 110 is mounted at approximately the mid-point or center of the gap between loader arms 301 of tractor 300, while the longitudinal axis of said central beam 110 is substantially aligned with the direction of travel of said tractor 300.

Central swivel hub 130 is disposed at distal end 112 of central beam member 110. Rigid forward extension member 150 has proximate end 151 and distal end 152; proximate end 151 is mounted to central swivel hub 130, while gusset plate member 153 provides structural support between said extension member 150 and central swivel hub 130. In a preferred embodiment, rigid forward extension member 150 is substantially aligned with the longitudinal axis of central beam 110.

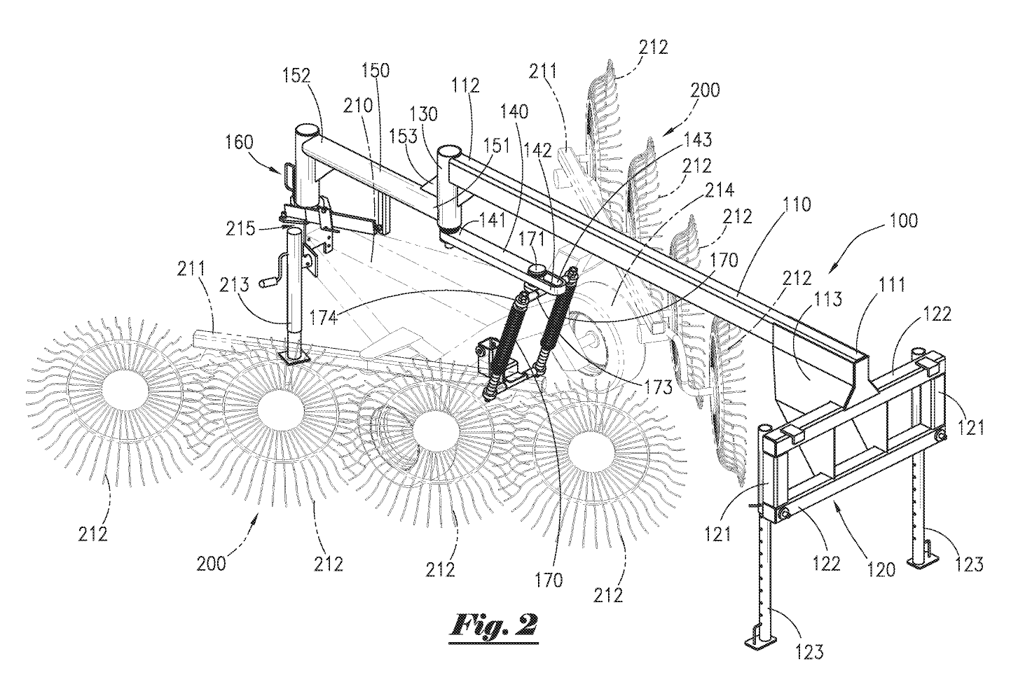

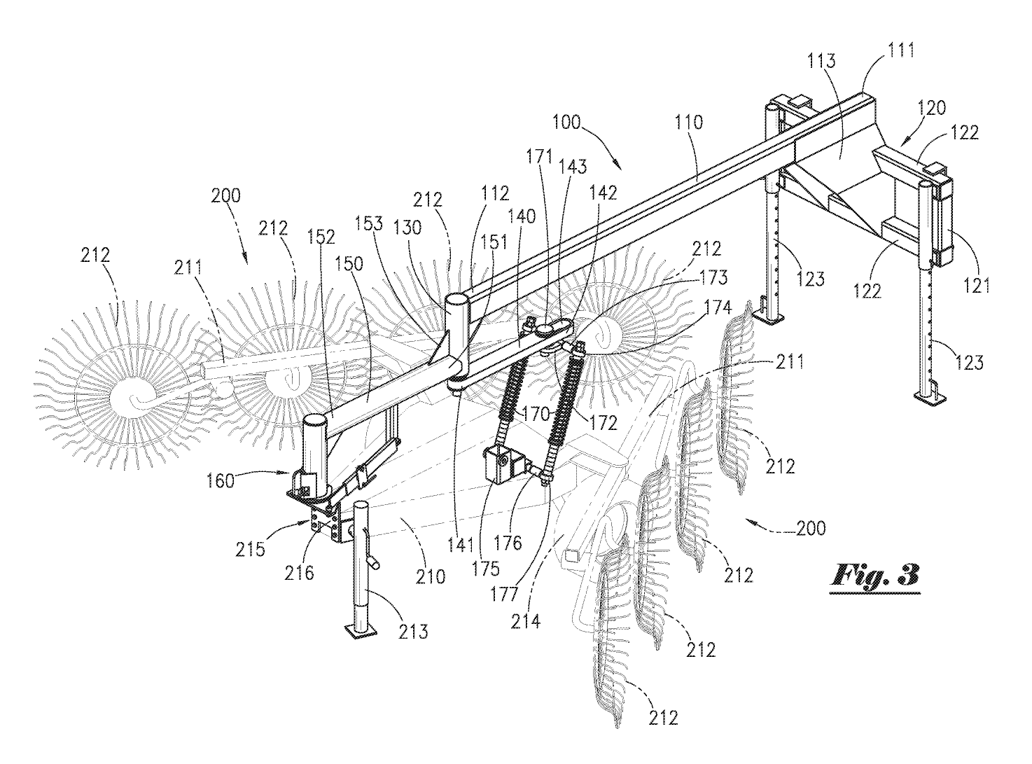

FIG. 2 depicts a rear perspective view of agricultural implement mounting assembly 100 of the present invention operationally attached to a conventional rake assembly 200, while FIG. 3 depicts a front perspective view of mounting assembly 100 operationally attached to said conventional rake assembly 200. As depicted in FIG. 2 and FIG. 3, said rake assembly 200 generally comprises a central frame body 210 supported on wheels 214. Angled mounting arms 211 are attached to said frame body 210, while a plurality of circular rake members 212 are disposed along said mounting arms 211.

A conventional hitch assembly 215 having upward facing hitch ball 217 (not visible in FIGS. 2 and 3) is disposed near the front or forward end of said frame body 210. It is to be observed that conventional rake assembly 200 is but one type of agricultural implement that can be beneficially operationally attached to mounting assembly 100; any number of other agricultural implements can also be operationally attached to said mounting assembly instead of said rake assembly 200. Front plate member 216 is attached to said hitch ball 215 assembly, while at least one adjustable jack stand 213 is attached to said front plate member 216. In a preferred embodiment, said at least one adjustable jack stand 213 can be tilted to a substantially horizontal position to avoid contact with an underlying terrain during use.

Still referring to FIGS. 2 and 3, elongate central beam member 110 has proximate end 111 and distal end 112. Rear mounting assembly 120 is disposed at said proximate end 111. Said mounting assembly 120 comprises rigid horizontal frame members 122 that extend between rigid vertical frame members 121. At least one adjustable jack stand 123 can be attached to said mounting assembly 120, while gusset support frame 113 reinforces and provides structural support to the connection of central beam 110 to mounting assembly 120.

Central swivel hub 130 is disposed at distal end 112 of central beam member 110. Rigid forward extension member 150 has proximate end 151 and distal end 152; proximate end 151 is mounted to central swivel hub 130, while gusset plate member 153 provides structural support between said extension member 150 and central swivel hub 130. Said rigid forward extension member 150 is substantially aligned with the longitudinal axis of central beam 110. A hitch connection assembly 160 is disposed at distal end 152 of rigid forward extension member 150.

In a preferred embodiment, steering arm 140 having forward end 141 and trailing end 142 is moveably attached to central swivel hub 130. Specifically, forward end 141 is pivotally attached to said central swivel hub 130 and can rotate about a pivot axis passing through said central swivel hub 130; trailing end 142 can move about a predetermined radius of travel. Elongate slot or aperture 143 is disposed near said trailing end 142 of steering arm 140.

Rotatable mounting post 171 is slidably received within said elongate slot 145, while mounting plate 172 is attached to said mounting post 171. Upper shock/strut arms 173 extend laterally from said mounting plate 172, while lateral upper shock/strut mounts 174 are disposed near the outer ends of said upper shock/strut arms 173. Lower mounting sleeve 175 can be operationally attached to frame body member 210 of rake assembly 200. Lower shock/strut arms 176 extend laterally from said lower mounting sleeve 175, while lateral lower shock/strut mounts 177 are disposed near the outer ends of said shock/strut arms 176. Shock/strut members 170 are mounted between and attached to upper strut mounts 174 and lower strut mounts 177.

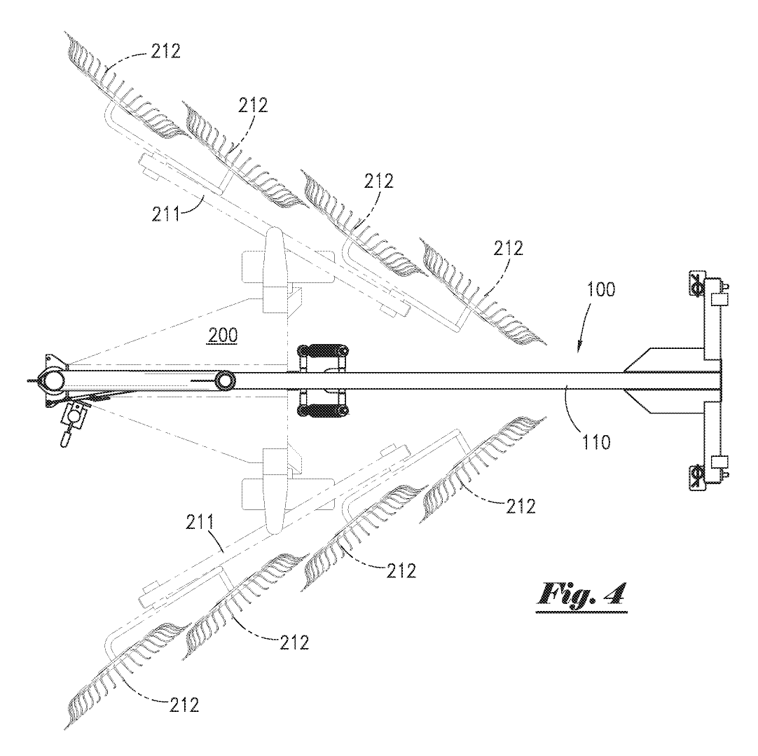

FIG. 4 depicts an overhead view of agricultural implement mounting assembly 100 of the present invention operationally attached to conventional rake assembly 200. In the configuration depicted in FIG. 4, central beam member 110 is disposed substantially down the central longitudinal axis of said rake assembly 200. Mounting arms 211 of rake assembly 200 are disposed at a converging acute angle to form a “V-shape”, with rake members 212 disposed on both sides of said central beam member 110. Steering arm 140 (not visible in FIG. 4) is aligned with and disposed below central beam 110.

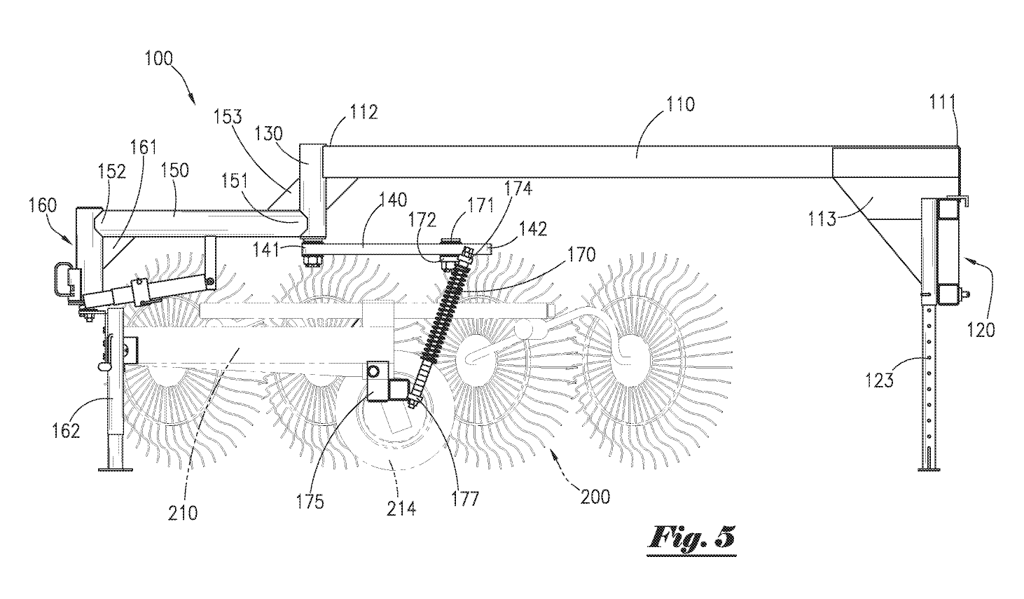

FIG. 5 depicts a side view of agricultural implement mounting assembly 100 of the present invention. Elongate central beam member 110 has proximate end 111 and distal end 112, with rear mounting assembly 120 disposed at said proximate end 111. Gusset support frame 113 reinforces and provides structural support to the connection of central beam 110 to mounting assembly 120. When mounting assembly 120 is not attached to a tractor (such as depicted in FIG. 1), adjustable jack stand 123 can be used to stabilize and lift mounting assembly 120 off of the ground or other underlying support surface.

Central swivel hub 130 is disposed at distal end 112 of central beam member 110. Proximate end 151 of rigid forward extension member 150 is mounted to central swivel hub 130, while hitch connection assembly 160 is disposed at distal end 152 of rigid forward extension member 150. Gusset plate member 153 is disposed between said extension member 150 and central swivel hub 130, while gusset plate member 161 is disposed between said extension member 150 and hitch connection member 160. When not attached to a tractor or other motorized vehicle, adjustable front jack stand 162 can be used to stabilize and support hitch connection assembly 160 off of the ground or other underlying support surface.

Steering arm 140 having forward end 141 and trailing end 142 is moveably attached to central swivel hub 130. Specifically, forward end 141 is pivotally attached to said central swivel hub 130 and can rotate about a pivot axis passing through said central swivel hub 130. Rotatable mounting post 171 is slidably mounted to said trailing end 142 (within said elongate slot 145, not visible in FIG. 5) while mounting plate 172 is attached to said mounting post 171. Lower mounting sleeve 175 is operationally attached to frame body member 210 of rake assembly 200. Shock/strut members 170 are mounted between upper strut mounts 174 and lower strut mounts 177.

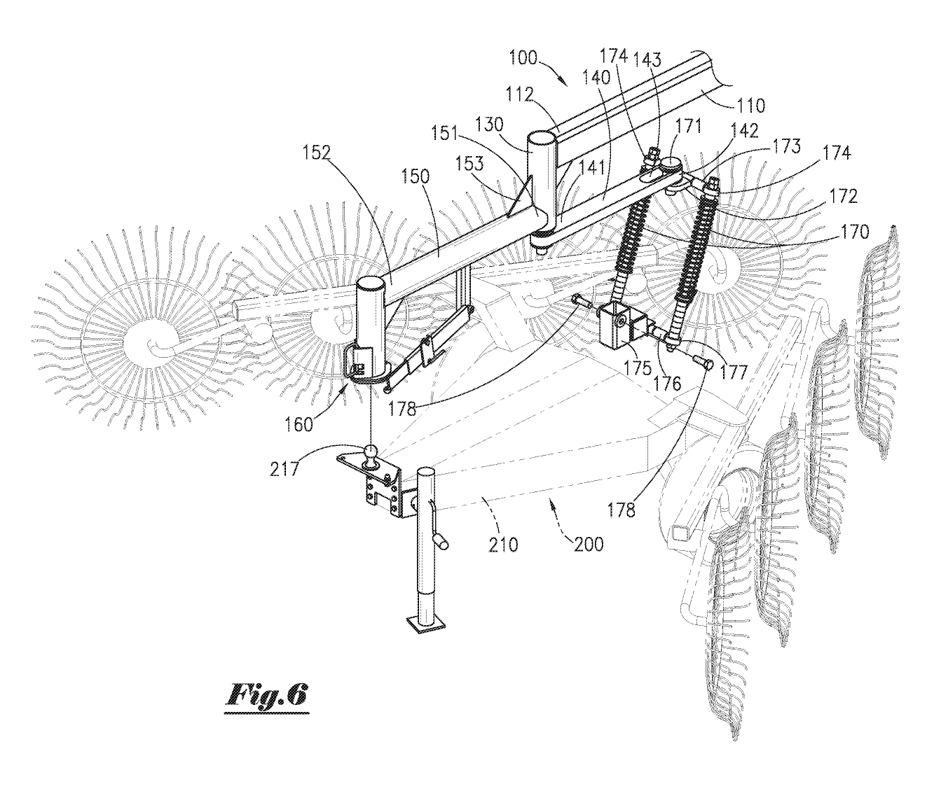

FIG. 6 depicts a perspective view of a front portion of agricultural implement mounting assembly 100 of the present invention. Central swivel hub 130 is disposed at distal end 112 of central beam member 110. Rigid forward extension member 150 has proximate end 151 and distal end 152; proximate end 151 is mounted to central swivel hub 130. Said rigid forward extension member 150 is substantially aligned with the longitudinal axis of central beam 110. A hitch connection assembly 160 is disposed at distal end 152 of rigid forward extension member 150, and is adapted to receive hitch ball 217 of rake assembly 200.

Steering arm 140 having forward end 141 and trailing end 142 is moveably attached to central swivel hub 130. Forward end 141 is pivotally attached to said central swivel hub 130 and can rotate about a pivot axis passing through said central swivel hub 130, while trailing end 142 can move about a predetermined radius of travel. Elongate slot or aperture 143 is disposed near said trailing end 142 of steering arm 140.

Rotatable mounting post 171 is slidably received within said elongate slot 143, while mounting plate 172 is attached to said mounting post 171. Upper shock/strut arms 173 extend laterally from said mounting plate 172, while lateral upper shock/strut mounts 174 are disposed near the outer ends of said upper shock/strut arms 173. Lower shock/strut arms 176 extend laterally from said lower mounting sleeve 175, while lateral lower shock/strut mounts 177 are disposed near the outer ends of said shock/strut arms 176. Shock/strut members 170 are mounted to and disposed between upper strut mounts 174 and lower strut mounts 177. Lower mounting sleeve 175 can be operationally attached to frame body member 210 of rake assembly 200 using fasteners 178.

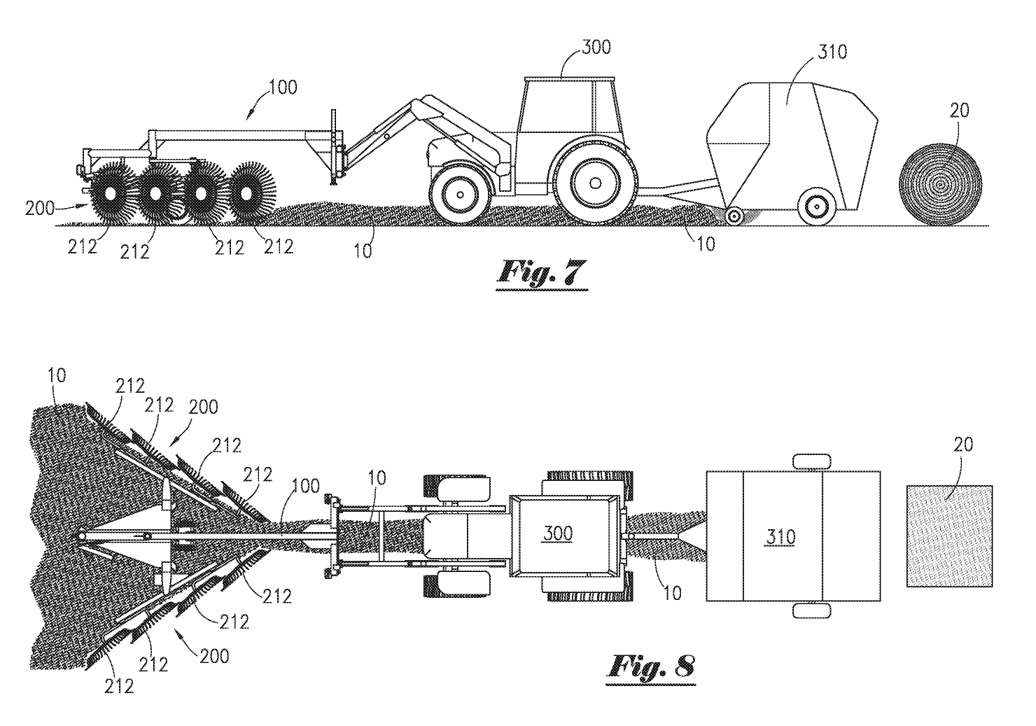

FIG. 7 depicts a side view of agricultural implement mounting assembly 100 of the present invention during a raking and bailing operation, while FIG. 8 depicts an overhead view of said implement mounting assembly 100 during said raking and bailing operation. As depicted in FIGS. 7 and 8, mounting assembly 100 is operationally attached to the front or forward facing end of a tractor (such as tractor 300) or other motorized vehicle, while conventional rake assembly 200 is operationally attached to said mounting assembly 100. A conventional bailer assembly 310 can be pulled or towed behind said tractor 300.

Still referring to FIGS. 7 and 8, grass 10 can be first cut using a conventional mower or other cutting device, thereby leaving said cut grass 10 remaining along the ground or other underlying surface. Thereafter, tractor 300 can pass over such cut grass 10 in a desired pattern. In operation, each rake member 212 can rotate in a clockwise or counter-clockwise direction, thereby providing a means for said rake members 212 to efficiently contact cut grass 10 and any underlying terrain or surface. In this manner, mounting assembly 100 operationally supports rake assembly 200, allowing said rake assembly 200 to rake cut grass 10 into organized rows. As said tractor 300 continues to move forward over said raked rows, said tractor 300 pulls conventional bailer assembly 310 over said organized rows of cut grass 10. Conventional bailer assembly 310 can then collect such cut grass 10 and form grass or hay bale 20 in a manner well known to those having skill in the art.

Although the operations depicted in FIGS. 7 and 8 involve a grass cutting and bailing operation, it is to observed that mounting assembly 100 can be used in connection with multiple different agricultural implements or operations, and can be used to harvest and/or otherwise process other agricultural products or herbaceous plant material besides grass 10.

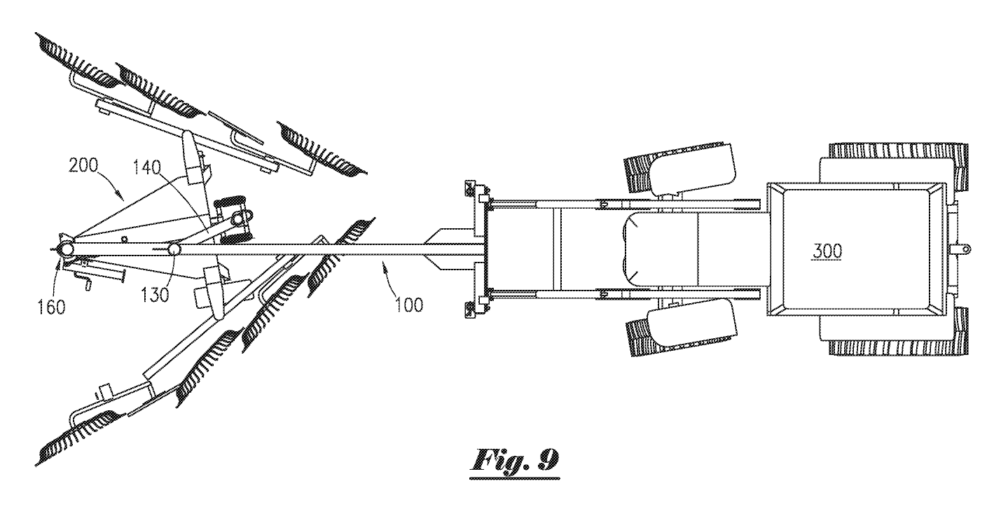

FIG. 9 depicts an overhead view of agricultural implement mounting assembly 100 of the present invention while being turned during a raking operation. Steering arm 140 can pivot about an axis passing through central swivel hub 130, thereby permitting rake assembly 200 to turn in response when a turn is made by tractor 300. The steering of mounting assembly 100 provides a tight turning radius, as well as responsive steering and maneuverability for front-mounted rake assembly 200. Such maneuverability of said mounting assembly 100 permits rake assembly 200 (or other agricultural implement operationally attached to mounting assembly 100) to easily accommodate a variety of different types of terrain.

In a preferred embodiment, the steering system of mounting assembly 100 is “passive”, such that the operational attachment of a rake assembly 200 (or other agricultural implement) to said mounting assembly 100 can alternatively turn and straighten by way of a “pull” from hitch connection member 160. Put another way, with the leading end of rake assembly 200 being “pulled” from hitch connection member 160, steering arm 140 can pivot about a desired radius in order to assist in turning, while still being able to keep an operationally attached implement in proper contact with an underlying surface. When said mounting assembly 100 is straightened, a forward motion of the front hitch can bring said mounting assembly back to a straight operation (such as, for example, straight row raking).

Further, said steering system can work in conjunction with a suspension assembly (including, without limitation, shock/struts 170) thereby properly sustaining full and constant contact between rake assembly 200 and an underlying ground or other surface. Mounting assembly 100 further keeps such an operationally attached rake or other implement from undesired lifting off of the ground or other underlying surface while turning, and thus, skipping large sections of said underlying surface. Said mounting assembly 100 is sufficiently flexible to beneficially permit an operationally attached implement to “float” over different types of terrain.

Additionally, steering of said mounting assembly 100 can be dampened and/or controlled by at least one optional motor. Further, a “centering” mechanism can be employed in order to center mounting assembly 100 while said mounting assembly 100 is being lifted and transported, thereby providing a means to lock said mounting assembly 100 in place as an additional safety measure.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A mounting assembly for mounting an agricultural implement having a hitch member to a motorized vehicle comprising:
a) an elongate beam having a first end, a second end and a length, wherein said first end of said beam is operationally attached to the front of said motorized vehicle; and
b) a hitch connector disposed at said second end of said beam and adapted to connect to said hitch member of said agricultural implement, wherein forward movement of said motorized vehicle tows said agricultural implement from said hitch connector.

2. The mounting assembly of claim 1, further comprising:
a) a swivel hub disposed along the length of said elongate beam;
b) a steering arm having a first end and a second end, wherein said first end of said steering arm is pivotally attached to said swivel hub; and
c) a linkage assembly connecting said second end of said steering arm to said agricultural implement.

3. The mounting assembly of claim 2, wherein said linkage assembly comprises at least one shock absorber or strut.

4. The mounting assembly of claim 2, wherein said elongate beam has a longitudinal axis and said steering arm is adapted to travel in a plane that is substantially parallel to said longitudinal axis.

5. The mounting assembly of claim 1, wherein said agricultural implement comprises a rake assembly.

6. The mounting assembly of claim 1, further comprising a mounting frame disposed at said first end of said elongate beam.

7. The mounting assembly of claim 1, wherein said motorized vehicle comprises a tractor.

8. A mounting assembly for mounting an agricultural implement having a hitch member to a motorized vehicle comprising:
a) an elongate beam having a first end and a second end, wherein said first end of said beam is operationally attached to the front of said motorized vehicle;
b) a swivel hub disposed at said second end of said beam;
c) an extension member having a first end and a second end, wherein said first end of said extension member is attached to said swivel hub; and
d) a hitch connection member disposed at said second end of said extension member, wherein forward movement of said motorized vehicle tows said agricultural implement from said hitch connector.

9. The mounting assembly of claim 8, further comprising:
a) a steering arm having a first end and a second end, wherein said first end of said steering arm is pivotally attached to said swivel hub and pivots about an axis that is substantially perpendicular to said steering arm; and
b) a linkage assembly connecting said second end of said steering arm to said agricultural implement.

10. The mounting assembly of claim 9, wherein said linkage assembly comprises at least one shock absorber or strut.

11. The mounting assembly of claim 9, wherein said elongate beam has a longitudinal axis and said steering arm can travel in a plane that is substantially parallel to said longitudinal axis.

12. The mounting assembly of claim 8, wherein said agricultural implement comprises a rake assembly.

13. The mounting assembly of claim 8, further comprising a mounting frame disposed at said first end of said elongate beam.

14. The mounting assembly of claim 8, wherein said motorized vehicle comprises a tractor.

15. A method for mounting a first agricultural implement having a hitch member to a motorized vehicle comprising:
a) attaching a mounting assembly to said motorized vehicle, wherein said mounting assembly comprises:
i) an elongate beam having a first end, a second end and a length, wherein said first end of said beam is operationally attached to said front of said motorized vehicle; and
ii) a hitch connector disposed at said second end of said beam;
b) connecting said hitch member of said first agricultural implement to said hitch connector;
c) moving said motorized vehicle forward, wherein such forward movement causes said first agricultural implement to be towed from said hitch connector.

16. The method of claim 15, wherein said mounting assembly further comprises:
a) a swivel hub disposed along the length of said elongate beam;
b) a steering arm having a first end and a second end, wherein said first end of said steering arm is pivotally attached to said swivel hub; and
c) a linkage assembly connecting said second end of said steering arm to said first agricultural implement.

17. The method of claim 16, wherein said linkage assembly comprises at least one shock absorber or strut.

18. The method of claim 16, wherein said elongate beam has a longitudinal axis and said steering arm can travel in a plane that is substantially parallel to said longitudinal axis.

19. The method of claim 15, further comprising the step of simultaneously pulling a second agricultural implement behind said motorized vehicle.

20. The method of claim 19, wherein said first agricultural implement comprises a rake assembly and said second agricultural implement comprises a bailer.
